(19) United States
(12) Patent Application Publication
(10) Pub. No.: US 2013/0024819 A1
(43) Pub. Date: Jan. 24, 2013

(54) SYSTEMS AND METHODS FOR GESTURE-BASED CREATION OF INTERACTIVE HOTSPOTS IN A REAL WORLD ENVIRONMENT

(71) Applicants: Eleanor Rieffel, Redwood City, CA (US); Donald Kimber, Foster City, CA (US); Chunyuan Liao, San Jose, CA (US); Qiong Liu, Milpitas, CA (US)

(72) Inventors: Eleanor Rieffel, Redwood City, CA (US); Donald Kimber, Foster City, CA (US); Chunyuan Liao, San Jose, CA (US); Qiong Liu, Milpitas, CA (US)

(73) Assignee: FUJI XEROX CO., LTD., Tokyo (JP)

(21) Appl. No.: 13/185,414

(22) Filed: Jul. 18, 2011

(51) Int. Cl. G06F 3/048

(52) U.S. Cl. 715/848

(57) ABSTRACT

Systems and methods provide for gesture-based creation of interactive hotspots in a real world environment. A gesture made by a user in a three-dimensional space in the real world environment is detected by a motion capture device such as a camera, and the gesture is then identified and interpreted to create a “hotspot,” which is a region in three-dimensional space through which a user interacts with a computer system. The gesture may indicate that the hotspot is anchored to the real world environment or anchored to an object in the real world environment. The functionality of the hotspot is defined in order to identify the type of gesture which will initiate the hotspot and associate the activation of the hotspot with an activity in the system, such as control of an application on a computer or an electronic device connected with the system.

### BACKGROUND

1. Field of the Invention

This invention relates to systems and methods for using gestures to create an interactive hotspot in a real world environment, and more particularly to using gestures to define the location and functionality of a hotspot.

2. Description of the Related Art

Advances in mixed reality and tracking technologies mean that it is easier than ever to enable events in the real world, such as movements or actions, to trigger application events in a digital environment, such as on a computer system. The information gleaned from a physical, real world space may have applications for remote control of devices, alternative interfaces with software applications, and enhanced interaction with virtual environments.

A “hotspot” is a region in real world space through which a user interacts with a system either explicitly or implicitly. A hotspot may act as an interface widget, or may define a region in which a system will look for certain types of activities. As will be further described below, these interactions can be simple, such as the intersection of a user's body or specific body part with the region or a user's hand pointing at a hotspot. The interactions may also be complex, such as making a prescribed gesture within a hotspot or touching a set of hotspots in a specified order or pattern. A set of hotspots, possibly together with other sorts of widgets, may form an interface. Hotspots are persistent and can be anchored to the real world in general, or to an object in the real world. Hotspot regions may be three-dimensional (3D) volumes, surfaces, or points, and may be homogeneous or non-homogeneous.

Currently, in camera-based systems, the location of a physical hotspot is often created by marking on the image captured by the camera, or by hand input of measured physical coordinates of the hotspot, or by indicating the location in a mirror world that corresponds to the real world environment.

While it is natural to use regions in the physical world as control points and interaction spaces, it is not easy to define these regions.

### SUMMARY

Systems and methods described herein provide for gesture-based creation of hotspots in a real world environment. A gesture made by a user in a three-dimensional space in the real world environment is detected by a motion capture device such as a camera, and the gesture is then identified and interpreted to create a “hotspot,” which is a region in three-dimensional space through which a user interacts with a computer system. The gesture may indicate that the hotspot is anchored to the real world environment or anchored to an object in the real world environment. The functionality of the hotspot is defined in order to identify the type of gesture which will initiate the hotspot and associate the activation of the hotspot with an activity in the system, such as control of an application on a computer or an electronic device connected with the system.

In one embodiment of the invention, a method for creating a hotspot in a real world environment comprises detecting a gesture of a user in a three-dimensional (3D) space of the real world environment using a motion tracking device; identifying and interpreting the gesture using a processor and a memory; creating a hotspot in the 3D space based on the identified and interpreted gesture; and associating the hotspot with at least one activity.

The method may further comprise providing feedback to the user when capturing the gesture and creating the hotspot.

The gesture may be a 3D gesture that includes movement of a user in three different dimensions.

The gesture may further comprise a hotspot-creating mode gesture which identifies that the gesture is intended to create the hotspot.

Creating the hotspot may further comprise defining an interaction with the hotspot to initiate the associated activity.

The identified gesture may define the interaction which will initiate the hotspot.

The method may further comprise interpreting the gesture to anchor the hotspot to the real world environment.

The method may further comprise interpreting the gesture to anchor the hotspot to a movable object in the real world environment.

The method may further comprise calibrating the motion tracking device with the real world environment prior to detecting a gesture.

The feedback provided to the user may provide a display of a virtual environment which matches the real world environment and illustrates a location and a size of the hotspot.

The hotspot may be a three-dimensional region in a space within the real world environment through which the user interacts with a system.

In another embodiment of the invention, a system for creating a hotspot in a real world environment comprises a motion capture unit which captures a gesture of a user in a three-dimensional (3D) space of the real world environment; a gesture processing unit which identifies and interprets the gesture using a processor and a memory and creates a hotspot in the 3D space based on the identified and interpreted gesture; and a gesture association unit which associates the hotspot with at least one activity.

The system may further comprise a feedback unit which provides feedback to the user when capturing the gesture and creating the hotspot.

The gesture may be a 3D gesture that includes movement of a user in three different dimensions.

The gesture may further comprise a hotspot-creating mode gesture which identifies that the gesture is intended to create the hotspot.

The gesture processing unit may define an interaction with the hotspot to initiate the associated activity.

The identified gesture may define the interaction which will initiate the hotspot.

The gesture may be interpreted to anchor the hotspot to the real world environment.

The gesture may be interpreted to anchor the hotspot to a movable object in the real world environment.

The system may further comprise a calibration unit which calibrates the motion capture unit with the real world environment.

The feedback unit may provide a display of a virtual environment which matches the real world environment and illustrates a location and a size of the hotspot.

The hotspot may be a three-dimensional region in a space within the real world environment through which the user interacts with a system.

In another embodiment of the invention, a computer program product for creating a hotspot in a real world environment may be embodied on a computer-readable medium and when executed by a computer, perform the method comprising detecting a gesture of a user in a three-dimensional (3D) space of the real world environment using a motion tracking device; identifying and interpreting the gesture; creating a hotspot in the 3D space based on the identified and interpreted gesture; and associating the hotspot with at least one activity.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 is a block diagram of a system for creating interactive hotspots in a real world environment, according to one embodiment of the invention;

FIG. 2 is an illustration of the real world environment in which a user may create hotspots using gestures, according to one embodiment of the invention;

FIG. 3 is an illustration of visual feedback provided to the user in the form of a mirror world which mirrors the real world environment;

FIG. 4 is an illustration of a user performing a gesture in a gesture-creating mode, according to one embodiment of the invention;

FIG. 5 is an illustration of a graphical user interface (GUI) used to select the interaction and association of the hotspot, according to one embodiment of the invention;

FIG. 6 is an illustration of a screen with a plurality of hotspots located thereon, according to one embodiment of the invention;

FIG. 7 illustrates a flow chart of a method of creating the hotspot using a gesture, according to one embodiment of the invention; and

FIG. 8 is a block diagram of a computer system upon which the system may be implemented.

### DETAILED DESCRIPTION

In the following detailed description, reference will be made to the accompanying drawings. The aforementioned accompanying drawings show by way of illustration and not by way of limitation, specific embodiments and implementations consistent with principles of the present invention.

Systems and methods described herein provide for gesture-based creation of hotspots in a real world environment. A gesture made by a user in a three-dimensional space in the real world environment is detected by a motion capture device such as a camera, and the gesture is then identified and interpreted to create a “hotspot,” which is a region in three-dimensional space through which a user interacts with a computer system. The gesture may indicate that the hotspot is anchored to the real world environment or anchored to an object in the real world environment. The functionality of the hotspot is defined in order to identify the type of gesture which will initiate the hotspot and associate the activation of the hotspot with an activity in the system, such as control of an application on a computer or an electronic device connected with the system.

A gesture may be a meaningful pose or motion performed by a user's body (or multiple users' bodies), and may include the pose or motion of the whole body or just a part of the body, such as an arm or even the fingers on a hand. The gesture may also be three-dimensional.

While it is natural to use regions in the physical, or real world environment, as control points and interaction spaces, it is not easy to define these regions. By enabling the definition of these regions to take place in physical space, the methods and systems described herein ease this process.

### I. System Architecture

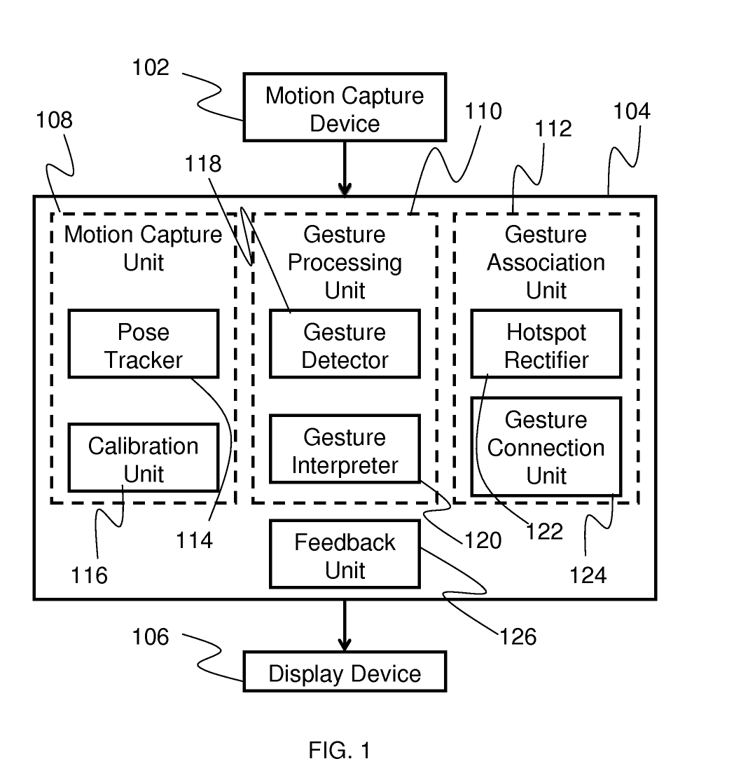

FIG. 1 illustrates a block diagram of one embodiment of a system for creating interactive hotspots. The system generally includes a motion capture device 102, a computer 104 and a display device 106. The motion capture device 102 captures the position and movement of a user as the user poses or makes a gesture. The motion capture device 102 may be a video camera, although the motion capture device could be as simple as a motion detector which detects motion in a particular area, in which case no image would actually be captured. The motion detector may then produce data relating to the motion for further processing. Although the following description uses an image capture device and image processing, one of skill in the art will appreciate that there are other ways to capture motion. The motion capture device 102 will capture an image or a sequence of images and then send the images to the computer 104. The computer 104 processes the images in order to determine if a gesture is being made and whether the use intends to create a hotspot. A further description of the processes carried out at the computer 104 is provided below. The display device 106 may serve different functions in the system, such as displaying a graphical user interface (GUI) for the user to interact with while performing a gesture and creating the interactive hotspot. The display device may also show an image of the real world space with an outline of the hotspot illustrated thereon, so that the user can determine if the hotspot was created in the correct location and has the appropriate properties. The display device 106 may also display applications and other software which have been programmed to work with the hotspots, as will be described further herein.

Various units may be present in the computer 104 which detect whether a gesture is being created and which determine the location of the gesture and thus the location of the hotspot. These units, including a motion capture unit 108, gesture processing unit 110 and gesture association unit 112, are described below.

The motion capture unit 108 captures a gesture of a user in a three-dimensional (3D) space of the real world environment, and may include a pose tracker 114 and a calibration unit 116. The motion capture unit 108 will also work directly with the motion capture device 102 in order to receive detected motion, such as video from a video camera. The pose tracker 114 is responsible for determining the pose of a user's body or a part of the body, such as the user's hands. The pose tracker 114 may rely upon image recognition or depth tracking to determine the pose that the user is in. One example is the Microsoft® Kinect™ device (Microsoft Corporation, Inc., Redmond, Wash.), which includes a camera and an infrared-structured light emitter and sensor to perform depth detection. Software, such as an OpenNITM application programming interface (API) (OpenNI Organization, www.openni.org; accessed Jul. 1, 2011) can then be executed on a computer connected with the KinectTM to interpret the image and light information and perform skeletal tracking.

The calibration unit 116 calibrates the motion tracking device 102 with the physical space when the gesture corresponds with a movable object in the room, or if the motion tracking device 102 may move. When the gesture is independent of location in space, or is fixed with respect to the camera's position and orientation, calibration is not necessary.

The gesture processing unit 110 identifies and interprets the gesture and creates a hotspot in the 3D space based on the identified and interpreted gesture. The gesture processing unit includes both a gesture detector 118 and gesture interpreter 120. The gesture detector 118 takes output from the pose tracker 114 and determines when the pose information should be passed on to the gesture interpreter 120 to be interpreted.

The gesture interpreter 120 is responsible for taking input from the gesture detector 118 and interpreting it. Some gestures are used to define a hotspot and its meaning; others are used to interact with the hotspot. Some gestures may be complex, and may unfold over time and over multiple locations. Many gestures may be simple, such as touching or pointing to a previously defined hotspot. In some cases, the hotspot may initiate differently depending on what body part of the user touches the hotspot.

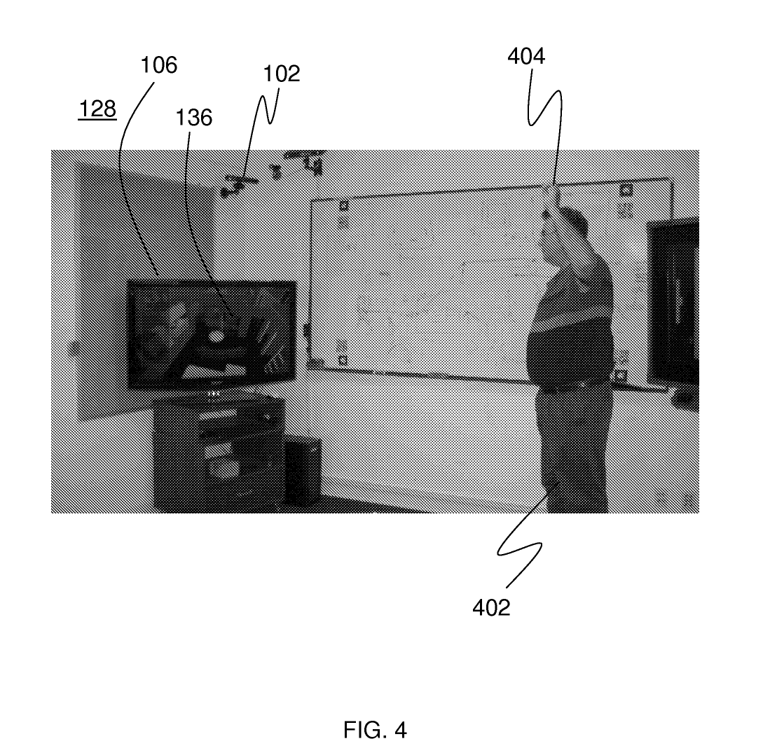

A part of a gesture may be used to indicate it is a defining gesture. In other words, the gesture may include a hotspot-creating mode gesture which identifies that the gesture is intended to create the hotspot. For example, as shown in FIG. 4, a user 402 with a raised left hand 404 may indicate that the right hand is defining a gesture. Alternatively, a hotspot-creating mode can be entered and exited through a gesture, or through another means such as pushing a button on a GUI or showing a specific marker, such as a QR code.

Once the hotspot has been created, the gesture association unit 112 associates the hotspot with at least one activity. A hotspot rectifier 122 may first be provided to perform functions such as finding the best fit plane for a set of points, making the angles of a hotspot exactly 90 degrees, or aligning edges of a hotspot with coordinate axes. The hotspot rectifier 122 may be needed since users' gestures to define a hotspot will generally be imprecise. The rectifier 122 can also use image processing to align hotspot edges with closely aligned features in the scene. This behavior is particularly useful if the intent is to define an object in the world as a hotspot.

The gestures described herein generally will initiate the hotspot to perform some activity, and this activity usually affects some application. The gesture connection unit 124 is responsible for making this connection. In some cases, the association will be programmed in at the time the gesture is defined, or may be chosen from a menu. In other cases, the gesture connection unit 124 may learn the association from examples. For example, a user could teach the system by repeatedly performing a gesture together with the action it should initiate in an application.

The feedback unit 126 interacts with the gesture detector 118, interpreter 120 and connection units 124 and gives users feedback as to when a gesture has been detected and what gesture has been detected. The feedback unit 126 can provide extremely simple feedback, such as a beep or the lighting of an indicator light, or complex feedback such as representing the gestures and their effect in a virtual environment or augmented reality overlay via projectors. In the latter case, the display device 106 is needed to display the virtual environment. The feedback could be haptic, or through head-mounted displays, or even holographic 3D displays in-situ.

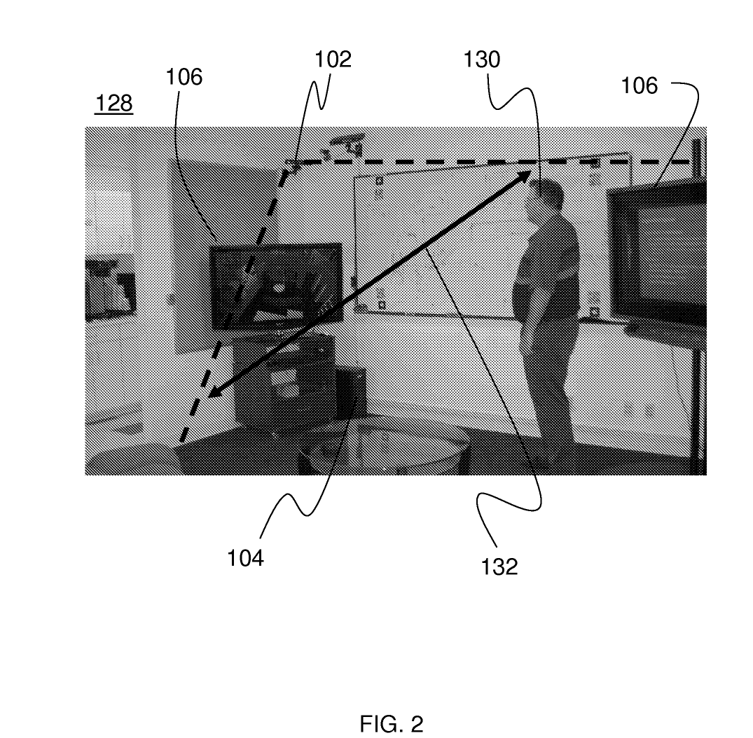

FIG. 2 is an illustration of the real world environment 128 in which a user may create hotspots using gestures, according to one embodiment of the invention. The environment includes at least one motion capture device 102, a computer 104 and a display device 106. The user 130 is positioned in the environment and can perform a gesture anywhere in the environment that is within the viewing range 132 of the motion capture device 102.

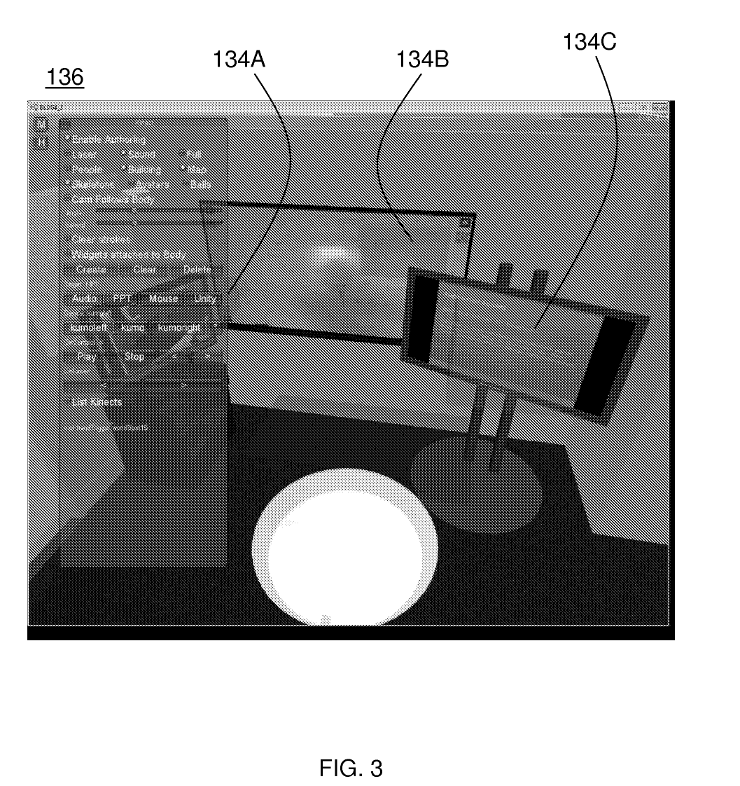

In one embodiment of the system, python scripts are used to talk with a Microsoft® Kinect™ device described above . Output from skeleton tracking is handled by these scripts which detect specific gestures to define hotspots and to carry out their associated behavior. In one embodiment, illustrated in FIG. 3, when initially defining elements of an interface, the hotspot elements 134A, 134B and 134C may be displayed on a display device displaying a mirror world 136 which mirrors the real world environment 128 shown in FIG. 2. Users use the visual feedback from the display device to learn how to use the interface and confirm the location and size of the hotspot 134. Other types of feedback may be provided in addition to or instead of the visual feedback from the display device, as will be discussed further below. As the users becomes more proficient, they need less feedback, and can use the interface without such a display.

### II. Defining Hotspot Locations

There are two stages to defining a hotspot: specifying its location and specifying its meaning, or functionality. In the embodiments described herein, the location of a hotspot is defined by a gesture. Its meaning, or functionality, may or may not be defined in whole or in part by a gesture. Below are some example gestures for defining the location of hotspots, although the gestures which may define the hotspot are certainly not limited thereto. All gestures may be performed while in a gesture definition mode, or while simultaneously performing another gesture that indicates that a hotspot is being defined, such as a raised left hand (see FIG. 4).

Polygonal hotspots: a user specifies points by pausing for a couple of seconds in the desired location for a vertex. Alternatively, the user could outline the shape.

Circular hotspots: a user could point (and pause) multiple times to the same location to indicate the center of a circle, and then draw a radial line outward and pause when the desired radius has been achieved.

Polyhedral hotspots: a polyhedral hotspot could be defined by using a gesture to define a plane, and using inference to determine the shape. A convex shape, and a number of more complex shapes, can be uniquely specified simply by defining each plane.

Spherical hotspots: This is similar to circular hotspots. Could be done with open hand, instead of fingers pinched together.

Hotline: pausing on just two points while in hotspot defining mode can define a line segment. A user crossing this line could initiate a certain behavior.

Hotpoint: holding one hand still, while the other one partially circles it, could define a hotpoint in which a gesture circling the point initiates a certain behavior.

Complex hotspots: a set of regions together can form a hotspot. These regions could be disconnected regions, or two adjacent non-coplanar regions, for example. A user might have to touch only one of the regions for a behavior to be initiated, or a user may need to touch all of them, possibly in a given order.

Moving hotspots: instead of using gestures to define a hotspot as a region in space, it can be used, together with image processing, to define an object as a hotspot. When the object moves, the hotspot functionality moves with the object; the original spatial coordinates are no longer the hotspot.

Anisotropic interfaces: movement in one direction within a hotspot may have a different effect than movement in another direction. For example, moving a hand right to left could affect the right/left balance between two speakers, moving up or down could adjust treble/bass, and moving front/back could adjust the volume. To define a hotspot that enables users to adjust the volume, we may specify just the max and min two-hand-distances that are mapping to the max and min volume. Any other distance-to-volume mapping can be interpolated from this pattern.

Inhomogeneous hotspots: for some hotspots, it does not matter where the user touches a hotspot or performs a gesture. In other cases, the location in the hotspot may be important, and gestures can be used to define this variation. For example, a long, thin rectangular hotspot could function as a volume control, and gestures can be used to indicate that it is a range hotspot, and which end corresponds to the maximum value, and which to the minimum.

Copied hotspots: a gesture encircling a hotspot with one hand, followed by both hands “picking up” the hotspot and placing it somewhere else could enable a hotspot to be copied to a different location, where further gestures could make modifications to it if desired. Similarly a “cut” gesture could remove a hotspots association with an object, and a “paste” gesture could form an association with another object. In this way, for example, a behavior could be moved from one part of a tangible interface to another.

Implicitly defined hotspot regions: a user can make a gesture requesting that a floor hotspot be defined, and the system creates a hotspot bounded by known building geometry such as walls and doors.

Each of these hotspots could be anchored to the world, or anchored to an object in the world which can be moved. The gesture, and more specifically the location where the user performs the gesture, will determine whether the hotspot is anchored to the world or to a movable object in the world.

In some cases, the hotspot boundary does not correspond to any features in the real space. These hotspots are referred to as the “intangible” elements of an interface, and an interface made up of only “intangible” elements will be called an “intangible interface.” On the other hand, the hotspots may correspond to objects in the world, such as an appliance, or to objects specifically created for the interface such as boxes drawn on a white board, or blocks placed on a table.

### III. Defining Hotspot Interactions

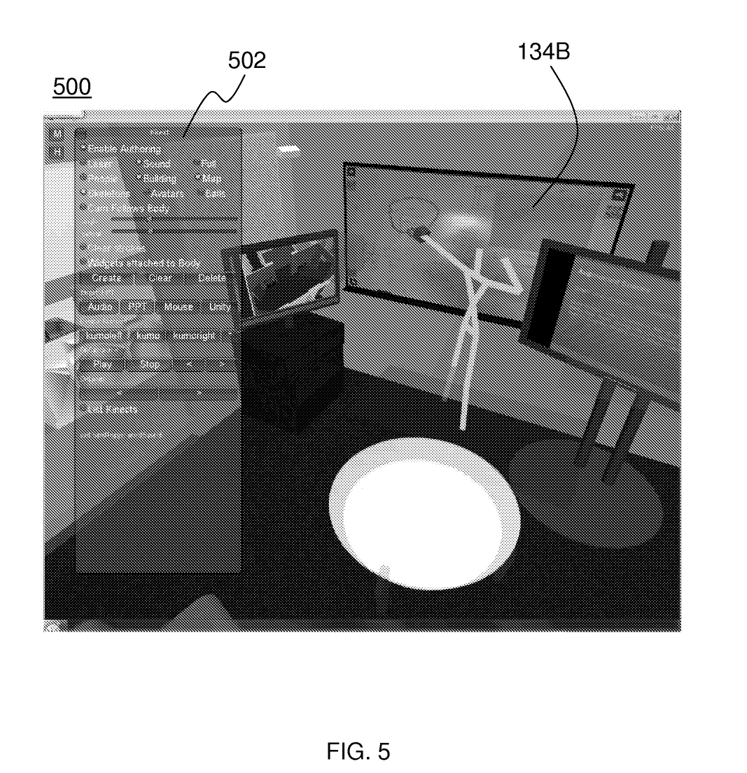

The user must define the type of interaction which will occur in the hotspot. The user interaction may be automatically defined based on the type of gesture used to create the hotspot, or the interaction may be selected from a menu 502 in a GUI 500, as shown in FIG. 5. The user can manipulate the menu 502 through gestures as well, thus allowing the user to maintain a position within the real world environment that is more convenient for creating hotspots.

With regard to the actual interactions, simply touching the hotspot may initiate an activity, but in some cases, a more sophisticated interaction may be desired. Both hands touching a hotspot might be required to initiate an event, and the distance between the hands could indicate how strong the event should be. For example, touching a hotspot with both hands could turn on a radio, and how far apart the hands are could indicate the desired volume. In other cases, performing a specific gesture in the hotspot might be required to initiate the activity. Sometimes two hotspots might be involved. For example, a user may touch a display hotspot, for a whiteboard or an electronic display, and then a printer hotspot to indicate a desire to have the current display printed. A single hotspot can support a complex “3D in-air Widget”, that reacts to a variety of touching, pointing, and more complex gestures in a rich set of ways. A user could interact with such special 3D zones, for example, by using two hands to adjust volume (proportional to the distance between them), one hand to “rotate” a virtual knob to change the AC temperature, a crossing gesture to delete an e-mail being read or a voice mail being listened to.

### IV. Defining Hotspot Associations

The desired effect of an interaction with a hotspot must be defined in some way so that the initiation of the hotspot translates into a meaningful activity. This association can be explicitly programmed by the user when defining the hotspot by adding code to the gesture interpreter 126 that talks to the desired application's application programming interface (API). Alternatively, a predetermined set of possible associations can appear in the menu 502 on a GUI 500 on the display device 106, as shown in FIG. 5. After creating the hotspot 134 and specifying the interaction, the user can choose the desired activity from the list which the gesture interpreter will associate with that hotspot and interaction from then on.

A more sophisticated way for the hotspot associations to be formed is for the system to learn the association from, for example, a user performing a gesture together with, or followed by, the desired action. The learning mode can be entered by a gesture, or some other means, such as a button click.

### V. Indicating the Existence of a Hotspot

There need not be any physical indication of a hotspot in the real world environment. Its existence may be detected by the effect that interactions have on a system, or by seeing an indication of the hotspot, such as a colored region, in a virtual model of the space, as shown by hotspots 134A, 134B and 134C in FIG. 3. In cases in which a hotspot is anchored to an object, there may be no need for an additional physical indication of a hotspot. In many cases, however, adding a physical indication of the hotspot will aid in use of the hotspot.

Possible indicators include sticky notes with simple graphics or barcodes, drawing on a surface, or placing 3D markers. Ideally the indicators would be easy to spot, but not distracting. In some cases, the physical indicators could be removed without impairing use once the user has interacted with the system long enough.

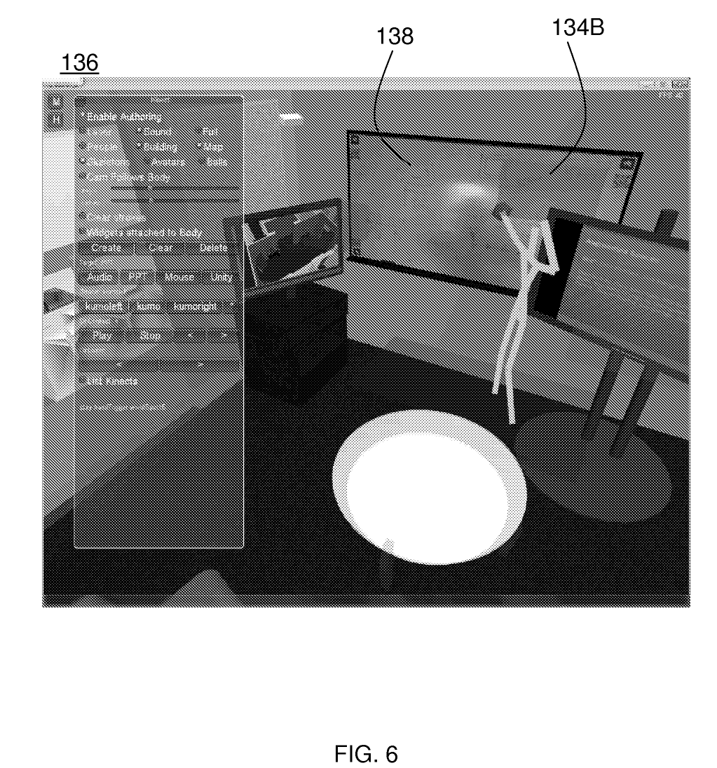

The indicators could also be embedded within the applications which they are associated with. For example, as shown in the mirror world illustration in FIG. 6, a presentation being given on a large projection screen 138 may have a hotspot 134B defined in a corner of the screen 138. If one set of hotspots is associated with going to the next slide or the previous slide in the presentation, the presentation software could provide an indicator (not shown) in each of the corners of the page which provides an arrow icon that provides a graphical representation of what will happen if the user interacts with that hotspot.

### VI. Method of Creating the Hotspot

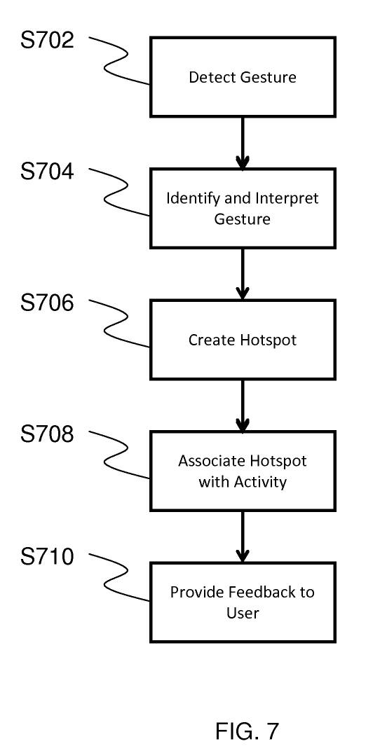

FIG. 7 illustrates one exemplary embodiment of a method for gesture-based creation of a hotspot in a real world environment. First, in step S702, a gesture of a user in a three-dimensional (3D) space of the real world environment is detected using a motion tracking device. In step S704, the gesture is identified and interpreted to determine the location and meaning of the gesture. In step S706, a hotspot is created in the 3D space of the real world environment based on the identified and interpreted gesture. In step S708, the hotspot is associated with at least one activity, such as an action in a software application or an adjustment to a setting on a device controlled by the system. In step S710, feedback is provided to the user when capturing the gesture and creating the hotspot.

### VII. Application for Creating and Modifying Interactive 3D Models

Gesture-based techniques can be used to define the geometry of a model of a real physical space by outlining the geometries of the space. Hotspot creation gestures can be used to create interactive zones in these models. Here are some examples:

Physical interaction with virtual objects: touching a hotspot defined on a drawer or door, or on a drawer or door's handle, in the physical space, can cause the drawer or door to open in the virtual model. The initial defining gesture can be used to specify how far the door or drawer should open.

Control spots: touching a hotspot on a wall can control the lighting in the real world environment or a virtual world environment, turning on and off the lights or rotating through a set of lighting options.

Appearance modifiers: similar to the control spots, touching a hotspot on the floor could rotate through a bunch of carpet color options.

Animation path definition and control: a gesture can be used to define an animation path. Through gestures, or other means such as a 2 dimensional barcode, an object to traverse that path can be chosen. Hotspot regions can be defined to control the animation. A two-handed hotspot interaction can, for example, control the speed with which the object traverses the path.

View control: when a user in front of a display showing a virtual world crosses a line in the real world environment, the display can react by showing a zoomed-in view of the virtual world.

### VIII. Application for Controlling Behavior of a Video Surveillance System

In one application of the inventive method, a video surveillance system may be controlled through the use of gesture-based hotspots. The features of such a surveillance system may include:

On/off tracking regions: a gesture performed in a hotspot region turns on or off tracking in that region.

On/off recording regions: a gesture turns on or off recording in the hotspot region.

Turn on or off trails: a tracked person entering the hotspot region results in tracking trails being turned on (or off).

Tracked person appearance: when a tracked person performs a gesture in hotspot region, the system changes the representation of the tracked person while in that region. For example, the user can change from a billboard representation to a personal avatar representation or to an impersonal column or an anonymous penguin representation.

Logging and alarms: when a tracked person enters a previously defined hotspot, or crosses a previously defined hotline, an alarm could go off, or the event logged for review.

Querying the system: pointing at a hotspot could tell the system to display the most recent event that happened in that region, or to give a list of the events in that region. A gesture could indicate which types of events are of interest, such as person loitering or more than two people in that spot.

No fixture room control: the room in question could be a conference room, a home, or a factory. Touching various hotspots on a wall can cause lights to turn on or off, screens to turn on and off or display content from a different machine. Sound can be turned on or off, or touching a volume hotspot for an audio system and then raising or lowering a hand could increase or decrease the volume. Thermostat can be adjusted. Electronically locked cabinets can be locked or unlocked. Streaming, recording, or video conferencing can be turned on or off. Various machines and appliances can be controlled. In this way, the users body acts as a type of universal remote control. Also, touching a particular hotspot could turn a user's hand into a pointing device for a display. Users can gain control of a display by entering a given hotspot. Access to a display could be controlled by “gesture passwords.” For example, in order to gain control of a display, a person has to touch a set of hotspots in the order of her “gesture password.” A person entering a hotspot, or touching a hotspot, could start a video playing. Gestures in that same hotspot could enable seeking within that video. If the system can identify a specific user, of if a user chooses a uniquely identifying pose hotspot, when the user enters the hotspot, their preloaded slides can come up on the screen, easing speaker transitions in meetings.

Personal information space: users can use this system to define a personal information space in a room or in a space around a user. The motivation is that the special memory can help users organize the increasing volume of personal information. For example, the user can define a “lab activity” hotspot on her calendar hung on the wall. By pointing her arm to the calendar, she can review the update-to-date employee activity list; similarly, she can define a “home monitoring” hotspot next to her chair, and use it to check the surveillance camera at her home. A user can define a “to-do list” hotspot on the wall above her desk. By touching the hotspot, she can hear her current to-do list. Interacting with a hotspot on her phone can bring up the VOIP interface. A different gesture can bring up the phone book. More generally, interacting with hotspots on a machine or object can bring up information or control interfaces associated with that object. Taking papers from a specific file drawer could open up related folder on the computer. A person could define regions in her own office in order to set status messages as to what she is doing in the office. A person can specify regions, possibly with poses or gestures, that indicate “I'm at my desk,” “I'm on the phone,” or specify a visitor area.

Augmented reality experience: hotspots can be defined so that when a mobile device held by the user enters a hotspot, augmented reality content appears on the device's screen. Uses include museum or factory tours, visualizing an alternative way for a room to be furnished, or augmented reality gaming. Gestures can be used to interact with this content, from having a virtual monster react to a human gesture to pointing to indicate desire for more details that can be shown on the device's screen. A device entering a hotspot, possibly combined with a specific gesture, can “pick up” augmented reality content and move it. The hotspot may or may not follow the content. Other gestures could modify the content: make it bigger, rotate it, bend it, or shorten it (applies to both object or video). A hotspot near a whiteboard or electronic display can be used to request a screenshot of the display. A gesture made on the display can indicate which region or window to shoot. A user could walk into an augmented reality “avatar closet,” and whichever avatar she walks into, that's how she will appear to herself and other users in the augmented reality display. Walking into a given hotspot can confer powers such as “virtual furniture mover” or greater strength to fight monsters.

Retail environment: the system can be used to define hotspots where customers running an appropriate application will see information about nearby products. The association can be created by taking a picture of the products' barcodes. The retailer can indicate boundaries of a hotspot for a particular product and then monitor amount of time spent in or number of people passing through the hot spot. With good person tracking, the retailer can also keep track of what product a customer heads to next in order to better organize the store. An interface could come up to aid a person if they stand a long time in one spot since that may indicate confusion about the products.

Prototyping interfaces: gesture-based hotspot definition enables fast prototyping of both tangible interfaces and GUIs. Through gestures a new hotspot can be created and another gesture can be used to transfer associated behavior from a previous hotspot. Alternatively, hotspot associated behavior can be chosen from a menu. The interface hotspots may correspond with elements in a sketched interface design or with blocks or other 3D objects for a tangible interface. For example, a remote control for a variety of appliances or a whole room could be sketched on a small, portable whiteboard. As the sketch is revised, hotspot associations can be updated.

### IX. Computer Embodiment

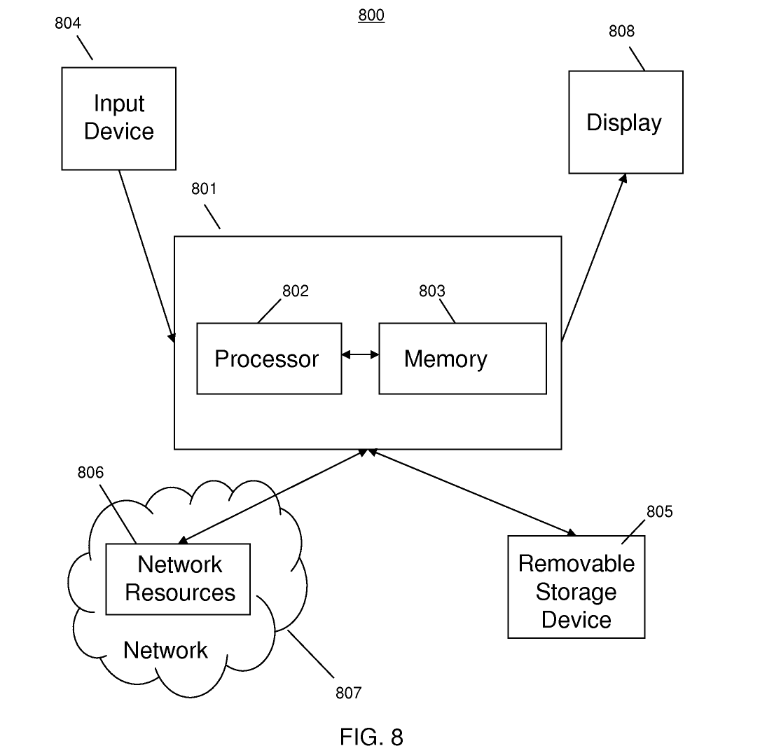

FIG. 8 is a block diagram that illustrates an embodiment of a computer/server system 800 upon which an embodiment of the inventive methodology may be implemented. The system 800 includes a computer/server platform 801 including a processor 802 and memory 803 which operate to execute instructions, as known to one of skill in the art. The term “computer-readable storage medium” as used herein refers to any tangible medium, such as a disk or semiconductor memory, that participates in providing instructions to processor 802 for execution. Additionally, the computer platform 801 receives input from a plurality of input devices 804, such as a keyboard, mouse, touch device or verbal command. The computer platform 801 may additionally be connected to a removable storage device 805, such as a portable hard drive, optical media (CD or DVD), disk media or any other tangible medium from which a computer can read executable code. The computer platform may further be connected to network resources 806 which connect to the Internet or other components of a local public or private network. The network resources 806 may provide instructions and data to the computer platform from a remote location on a network 807. The connections to the network resources 806 may be via wireless protocols, such as the 802.11 standards, Bluetooth® or cellular protocols, or via physical transmission media, such as cables or fiber optics. The network resources may include storage devices for storing data and executable instructions at a location separate from the computer platform 801. The computer interacts with a display 808 to output data and other information to a user, as well as to request additional instructions and input from the user. The display 808 may therefore further act as an input device 804 for interacting with a user.

The embodiments and implementations described above are presented in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

1. A method for creating a hotspot in a real world environment, comprising:
detecting a gesture of a user in a three-dimensional (3D) space of the real world environment using a motion tracking device;
identifying and interpreting the gesture using a processor and a memory;
creating a hotspot in the 3D space based on the identified and interpreted gesture; and
associating the hotspot with at least one activity,
wherein the gesture further comprises a hotspot-creating mode gesture which identifies that the gesture is intended to create the hotspot.

2. The method of claim 1, further comprising providing feedback to the user when capturing the gesture and creating the hotspot.

3. The method of claim 1, wherein the gesture is a 3D gesture that includes movement of a user in three different dimensions.

4. (canceled)

5. The method of claim 1, wherein creating the hotspot further comprises defining an interaction with the hotspot to initiate the associated activity.

6. The method of claim 5, wherein the identified gesture defines the interaction which will initiate the hotspot.

7. The method of claim 1, comprising interpreting the gesture to anchor the hotspot to the real world environment.

8. The method of claim 1, comprising interpreting the gesture to anchor the hotspot to a movable object in the real world environment.

9. The method of claim 8, further comprising calibrating the motion tracking device with the real world environment prior to detecting a gesture.

10. The method of claim 2, wherein the feedback provided to the user provides a display of a virtual environment which matches the real world environment and illustrates a location and a size of the hotspot.

11. The method of claim 1, wherein the hotspot is a three-dimensional region in a space within the real world environment through which the user interacts with a system.

12. A system for creating a hotspot in a real world environment, comprising:
a motion capture unit which captures a gesture of a user in a three-dimensional (3D) space of the real world environment;
a gesture processing unit which identifies and interprets the gesture using a processor and a memory and creates a hotspot in the 3D space based on the identified and interpreted gesture; and
a gesture association unit which associates the hotspot with at least one activity
wherein the gesture further comprises a hotspot-creating mode gesture which identifies that the gesture is intended to create the hotspot.

13. The system of claim 12, further comprising a feedback unit which provides feedback to the user when capturing the gesture and creating the hotspot.

14. The system of claim 13, wherein the gesture is a 3D gesture that includes movement of a user in three different dimensions.

15. (canceled)

16. The system of claim 12, wherein the gesture processing unit defines an interaction with the hotspot to initiate the associated activity.

17. The system of claim 16, wherein the identified gesture defines the interaction which will initiate the hotspot.

18. The system of claim 12, wherein the gesture is interpreted to anchor the hotspot to the real world environment.

19. The system of claim 12, wherein the gesture is interpreted to anchor the hotspot to a movable object in the real world environment.

20. The system of claim 19, further comprising a calibration unit which calibrates the motion capture unit with the real world environment.

21. The system of claim 13, wherein the feedback unit provides a display of a virtual environment which matches the real world environment and illustrates a location and a size of the hotspot.

22. The system of claim 12, wherein the hotspot is a three-dimensional region in a space within the real world environment through which the user interacts with a system.

23. A computer program product for creating a hotspot in a real world environment, the computer program product embodied on a computer-readable medium and when executed by a computer, performs the method comprising:
detecting a gesture of a user in a three-dimensional (3D) space of the real world environment using a motion tracking device;
identifying and interpreting the gesture;
creating a hotspot in the 3D space based on the identified and interpreted gesture; and
associating the hotspot with at least one activity,
wherein the gesture further comprises a hotspot-creating mode gesture which identifies that the gesture is intended to create the hotspot.

24. The method of claim 1, wherein the hotpot-creating mode gesture comprises a raised hand, which indicates that the gesture is intended to create the hotspot.

25. The method of claim 1, wherein a hotspot-creating mode is entered and exited through pushing a button on a graphical user interface or showing a quick response (QR) code.

26. The method of claim 2, wherein the feedback to the user occurs through at least one of haptic, a head-mounted display, and a holographic 3D display.

27. The method of claim 2, wherein the feedback to the user is provided through a beep or a lightning of an indicator light.
